(19) United States
(12) Patent Application Publication
(10) Pub. No.: US 2003/0119917 A1
(43) Pub. Date: Jun. 26, 2003

(54) Dispersible silicone compositions

(76) Inventors: Kenneth Christopher Fey, Midland, MI (US); James Habermehl, Midland, MI (US)

Correspondence Address: Dow Corning Corporation, Intellectual Property Dept. - CO1232, P.O. Box 994, Midland, MI, 48686-0994, US

(21) Appl. No.: 10/256,670

(22) Filed: Sep. 27, 2002

Related U.S. Application Data
(63) Continuation-in-part of application No. 08/635,119, filed on Apr. 19, 1996, now abandoned.

(51) Int. Cl. C09K 3/00

(52) U.S. Cl. 516/13

(57) ABSTRACT

The present invention relates to a dispersible silicone composition comprising a blend of (I) a silicone composition prepared by reacting (i) a polyorganosiloxane, (ii) a silicon compound, and (iii) a catalytic amount of a compound for promoting the reaction of the other components and (II) a polyisobutylene compound. The polyisobutylene oligomer or polyisobutylene polymer is effective as a dispersing agent for the silicone composition (I). The polyisobutylene-containing compositions are easier to handle, produce less waste, and their dispersion into mineral oil formulations is more efficient.

### CROSS-REFERENCE TO RELATED APPLICATIONS

This patent application is a continuation-in-part of U.S. patent application Ser. No. 08/635,119, filed Apr. 19, 1996, pending.

### DESCRIPTION

This invention relates to dispersible silicone compositions. More particularly, this invention relates to dispersible silicone compositions comprising a blend of a silicone composition and a polyisobutylene compound.

The use of various silicone containing compositions as antifoams or defoamers is known. In this regard, it is well established that this art is highly unpredictable and slight modification can greatly alter the performance of such compositions. Most of these compositions contain silicone fluid (usually dimethylpolysiloxane), often in combination with small amounts of silica filler. Additionally, these compositions may include various surfactants and dispersing agents in order to impart improved foam control or stability properties to the compositions.

Silicone compositions which are useful as foam control agents have been taught in the art. For example, Aizawa et al., in U.S. Pat. Nos. 4,639,489 and 4,749,740, the disclosures of which are hereby incorporated by reference, teach a method for producing a silicone defoamer composition wherein a complex mixture of polyorganosiloxanes, filler, a resinous siloxane and a catalyst to promote reaction of the other components are heated together at 50° C. to 300° C.

More recently, a method for preparing a composition similar to that described by Aizawa et al., cited supra, was disclosed by Miura in U.S. Pat. No. 5,283,004, the disclosure of which is hereby incorporated by reference. In this disclosure, the above mentioned complex silicone mixture additionally contains at least 0.2 weight parts of an organic compound having at least one group selected from —COR, —COOR′ or —(OR″)ₙ—, wherein R and R′ are hydrogen or a monovalent hydrocarbon group, R″ is a divalent hydrocarbon group having 2 to 6 carbon atoms and the average value of n is greater than one. It is further disclosed that all the ingredients, including a catalyst, must be reacted at elevated temperatures to obtain the desired antifoam agent.

John et al., in European Patent Application No. 217,501, published Apr. 8, 1987, discloses a foam control composition which gives improved performance in high foaming detergent compositions which comprises (A) a liquid siloxane having a viscosity at 25° C. of at least 7×10⁻³ m²/s and which was obtained by mixing and heating a triorganosiloxane-endblocked polydiorganosiloxane, a polydiorganosiloxane having at least one terminal silanol group and an organosiloxane resin, comprising monovalent and tetravalent siloxy units and having at least one silanol group per molecule, and (B) a finely divided filler having its surface made hydrophobic. John et al. further describes a method for making the foam control compositions and detergent compositions containing said foam control compositions.

Starch, in U.S. Pat. No. 4,983,316 discloses a dispersible antifoam composition for providing controlled foaming liquid laundry detergent formulations and wherein there is provided a non-aqueous emulsion of primary and secondary silicone antifoam agents, at least one nonionic silicone surfactant for emulsifying the primary and secondary antifoaming agents in a solvent, a first organic surfactant dispersing agent for assisting in dispersing the emulsified primary and secondary antifoaming agents in the liquid laundry detergents, and a second dispersing agent of a nonionic difunctional block-copolymer terminating in primary hydroxyl groups for further assisting in dispersing the emulsified primary and secondary antifoam agents in the liquid laundry detergent. A liquid laundry detergent composition containing the composition described immediately above is also disclosed. Starch, in U.S. Pat. No. 4,978,471 discloses a composition which contains essentially the same components as in the '316 patent, however in the '471 patent the secondary antifoam agent is a blend of a polydimethylsiloxane substituted with polar groups and a polydimethylsiloxane fluid.

Terae et al., in U.S. Pat. No. 4,690,713, discloses an antifoam composition comprising (a) 100 parts by weight of a hydrocarbon oil, such as a spindle oil or silicone fluid (e.g. a polydimethylsiloxane fluid having a viscosity of 20 to 1,000,000 centistokes at 25° C., (b) 0.1 to 40 parts by weight of an organosilane compound having 1 to 3 hydroxy groups or hydrolyzable groups (such as alkoxy, acyloxy, and alkenyloxy groups), (c) 1 to 40 parts by weight of a finely divided silica powder and optionally a catalyst.

Foam control compositions which contain polybutylene or polyisobutylene compounds have also been disclosed. For example, Smith et al. in U.S. Pat. No. 3,959,175 discloses a defoamer based on a mixture of polyisobutylene and a high melting point hydrophobic component such as a fatty amide, fatty acid, or tri-gylceride, a mixture of the polyisobutylene and a hydrophobic material such as treated silica powder, or a combination of the two mixtures.

Canadian Patent Publication No. 2110523 discloses a defoaming composition which is prepared by heating a mixture of polyalphaolefin such as polybutene or polyisobutylene, diethylene triamine, polydimethylsiloxanediol, and silica, adding ethylene-bis-stearamide, and then adding that mixture to a mixture of polyalphaolefin, polydimethylsiloxane, polyether-modified polysiloxane, and polypropylene glycol.

Hauenstein et al. in U.S. Pat. No. 5,442,010 discloses an antifoam composition comprising a polydimethylsiloxane having a viscosity of greater than about 2 mm/²/s at 25° C. and a polyisobutylene oligomer having a number average molecular weight of about 200 to about 3,000 and having at least one end terminated with an epoxy-containing group.

It has now been discovered that polyisobutylene fluids are effective dispersing agents for silicone compositions such as those disclosed by Aizawa et al., cited supra. It is an object of the present invention to prepare silicone compositions which can be advantageously utilized in foam producing systems. It is a further object of the present invention to provide silicone compositions wherein there is provided improvement in the control of foaming behavior. It is a further object of the present invention to provide silicone compositions which are stable and easily dispersible.

The present invention relates to a dispersible silicone composition comprising a blend of (I) a silicone composition prepared by reacting at a temperature of 50° C. to 300° C. a mixture comprising: (i) 100 parts by weight of at least one polyorganosiloxane selected from (A) a polyorganosiloxane having a viscosity of about 20 to 100,000 mm²/s at 25° C. and being expressed by the general formula R¹ₐSiO_{(4-a)/2} in which R¹ is a monovalent hydrocarbon or halogenated hydrocarbon group having 1 to 10 carbon atoms and a has an average value of 1.9 to 2.2, (B) a polyorganosiloxane having a viscosity of 200 to about 100 million mm²/s at 25° C. expressed by the general formula R²_{b}(R³O)_{c}SiO_{(4-b-c)/2} in which R² is a monovalent hydrocarbon or halogenated hydrocarbon group having 1 to 10 carbon atoms, R³ is hydrogen or a monovalent hydrocarbon group having 1 to 10 carbon atoms, b has an average value of 1.9 to 2.2 and c has a sufficiently large value to give at least one —OR³ group in each molecule, at least one such —OR³ group being present at the end of the molecular chain, or (C) a mixture of (A) and (B); (ii) 0.5 to 20 parts by weight of at least one silicon compound selected from (a) an organosilicon compound of the general formula R⁴_{d}SiX_{4-d} in which R⁴ is a monovalent hydrocarbon group having 1 to 5 carbon atoms, X is selected from a halogen atom or a hydrolyzable group and d has an average value of one or less, (b) a partially hydrolyzed condensate of said compound (a), (c) a siloxane resin comprising (CH₃)₃SiO_{½} units and SiO_{4/2} units wherein the ratio of (CH₃)₃SiO_{½} units to SiO_{4/2} units is 0.4:1 to 1.2:1, or (d) a condensate of said compound (c) with said compound (a) or (b); and (iii) a catalytic amount of a compound for promoting the reaction of components (i) and (ii); and (III) a polyisobutylene compound.

The compositions of this invention comprise silicone composition (I) and polyisobutylene compound (II). Component (I) of the present invention can be prepared by reacting (i) a polyorganosiloxane, (ii) a silicon compound, and (iii) a catalytic amount of a compound for promoting the reaction of the other components.

Component (i) may be selected from (A) polyorganosiloxanes comprising siloxane units of the general formula R¹ₐSiO_{(4-a)/2} and having a viscosity of 20 to 100,000 mm²/s (centistokes (cS)) at 25° C. The organo groups R¹ of the polyorganosiloxane (A) are the same or different monovalent hydrocarbon or halogenated hydrocarbon groups having one to ten carbon atoms. Specific examples thereof are well known in the silicone industry and include methyl, ethyl, propyl, butyl, octyl, trifluoropropyl, phenyl, 2-phenylethyl and vinyl groups. The methyl group is particularly preferred. In the above formula, a has a value of 1.9 to 2.2. It is particularly preferred that polyorganosiloxane (A) is a trimethylsilyl-terminated polydimethylsiloxane having a viscosity of about 350 to 15,000 mm²/s at 25° C.

Alternatively, component (i) may be selected from (B) polyorganosiloxanes comprising siloxane units of the general formula R²_{b}(R³O)_{c}SiO_{(4-b-c)/2} and having a viscosity of 200 to 100 million centistokes at 25° C. wherein R² is independently selected from the monovalent hydrocarbon or halogenated hydrocarbon groups designated for group R¹, R³ is a hydrogen atom or R², and the —OR³ group is present at least at the end of a molecular chain of the polyorganosiloxane. The value of b is from 1.9 to 2.2 and c has a value so as to provide at least one —OR³ group per molecule. It is particularly preferred that polyorganosiloxane (B) is a hydroxyl-terminated polydimethylsiloxane having a viscosity of about 1,000 to 50,000 mm²/s at 25° C. Component (i) may also be (C) a mixture of (A) and (B) in any proportion.

Component (ii) is at least one silicon compound selected from (a) to (d): (a) an organosilicon compound of the general formula R⁴_{d}SiX_{4-d} wherein R⁴ is a monovalent hydrocarbon group having one to five carbon atoms, X is a halogen atom or a hydrolyzable group such as —OR or —OR⁶OR⁷, in which R⁶ is a divalent hydrocarbon group having one to five carbon atoms and R⁵ and R⁷ are each a hydrogen atom or a monovalent hydrocarbon group having one to five carbon atoms, the average value of d not exceeding 1, (b) a partially hydrolyzed condensate of the compound (a), (c) a siloxane resin comprising (CH₃)₃SiO_{½} and SiO₂ units and having a (CH₃)₃SiO_{½}/SiO₂ ratio of 0.4/1 to 1.2/1, or (d) a condensate of the siloxane resin (c) with the compound (a) or (b). It is preferred that component (ii) is selected from either an alkyl polysilicate wherein the alkyl group has one to five carbon atoms, such as methyl polysilicate, ethyl polysilicate and propyl polysilicate, or the siloxane resin (c). Most preferably, component (ii) is either ethyl polysilicate or a siloxane resin copolymer comprising (CH₃)₃SiO_{½} units and SiO₂ units in a molar ratio of approximately 0.4:1 to 1.2:1.

Component (iii) is a compound used as a catalyst for promoting the reaction of the other components. Any compound which promotes condensation reactions or rearrangement/condensation reactions is suitable as component (iii). It is preferably selected from siloxane equilibration catalysts, silanol-condensing catalysts, or a combination thereof. Catalysts suitable as component (iii) are exemplified by alkali metal hydroxides such as potassium hydroxide, sodium hydroxide, or cesium hydroxide, alkali metal silanolates such as potassium silanolate, alkali metal alkoxides such as potassium isopropoxide or potassium ethoxide, quaternary ammonium hydroxides such as beta-hydroxyethyltrimethyl ammonium hydroxide, benzyltrimethyl ammonium hydroxide, and tetramethyl ammonium hydroxide, quaternary ammonium silanolates, quaternary phosphonium hydroxides such as tetrabutyl phosphonium hydroxide and tetraethylphosphonium hydroxide, quaternary phosphonium silanolates, metal salts of organic acids such as dibutyltin dilaurate, stannous acetate, stannous octanoate, lead napthenate, zinc octanoate, iron 2-ethylhexoate, and cobalt naphthenate, mineral acids such as sulfuric or hydrochloric acid, organic acids such as acetic acid or organosulfonic acids, and ammonium compounds such as ammonium carbonate or ammonium hydroxide. It is preferred that the catalyst is selected from potassium silanolate, potassium hydroxide, or sodium hydroxide.

The mixture of (I) can further comprise up to 30 parts by weight of component (iv) a finely divided filler. The finely divided filler is exemplified by fumed, precipitated, or plasmatic TiO₂, Al₂O₃, Al₂O₃/SiO₂, ZrO₂/SiO₂, and SiO₂. The finely divided filler can be hydrophilic or hydrophobic. The filler can be hydrophobed during manufacture (i.e. in-situ) or independently. Various grades of silica having a particle size of several millimicrons to several microns and a specific surface area of about 50 to 1000 m²/g are commercially available and suitable for use as component (iv).

The mixture of (I) can further comprise up to 20 parts by weight of component (v), a polyorganosiloxane comprising siloxane units of the general formula R⁸ₑ(R⁹O)_{f}SiO_{(4-e-f)/2} and having a viscosity of 5 to 200 mm²/s at 25° C. wherein R⁸ is a monovalent hydrocarbon or halogenated hydrocarbon group having one to ten carbon atoms and R⁹ is hydrogen or a monovalent hydrocarbon group having one to ten carbon atoms. The value of e is between 1.9 and 2.2 and f has a value so as to provide two or more —OR⁹ groups in each molecule. It is particularly preferred that component (v) is a hydroxyl-terminated polydimethylsiloxane having a viscosity of about 10 to 100 mm²/s at 25° C. It is preferred that component (v) is added when filler (iv) is a hydrophilic silica.

A mixture of components (i), (ii), and (iii), optionally containing components (iv) and/or (v), is reacted under heat to produce the silicone composition (I), the proportions of the various components being: Component (i)—100 parts by weight; Component (ii)—0.5 to 20, preferably 1 to 7, parts by weight; Component (iii)—A catalytic amount (usually in the range of 0.03 to 1 part by weight); Component (iv), if present,—from greater than 0 to 30, preferably 1 to 15, and highly preferred is 5 to 15 parts by weight; Component (v), if present,—from greater than 0 to 20, preferably 1 to 10, parts by weight.

The proportions of components (A) and (B) used depends largely on their respective viscosities. It is preferable to use a mixture of (A) and (B) which has a viscosity of 1,000 to 100,000 mm ²/s at 25° C.

The silicone composition (I) is prepared by first mixing components (i), (ii), and (iii) and heating this blend to about 110 to 120° C. Finely divided filler (iv), if desired, is then uniformly mixed in using an appropriate dispersing device, such as a homomixer, colloid mill or triple roll mill. The resulting mixture is heated at a temperature of 50° C. to 300° C., preferably 100° C. to 300° C., and reacted for one to eight hours, although the reaction time varies depending on the temperature. If component (v) is to be employed in the composition, it is generally added after the filler (iv). It is preferable to carry out all mixing and heating operations in an inert gas atmosphere in order to avoid any danger and to remove volatile matter (unreacted matter, by-products, etc.). The mixing order of the components and the heating temperature and time as hereinabove stated are not believed critical, but can be changed as required. It is further preferred that, after reaction, the catalyst is neutralized to further stabilize silicone composition (I).

Alternatively, silicone composition (I) preferably comprises a diorganopolysiloxane, a silicon compound, and a catalyst for promoting the reaction of these components, this combination optionally containing a filler such as silica. These systems contain a mixture of a trimethylsilyl-terminated polydimethylsiloxane and a diorganopolysiloxane having silicon-bonded hydroxyl groups or silicon-bonded alkoxy groups along its main chain or at its chain ends, said alkoxy groups having from 1 to 6 carbon atoms. The silicon compound (ii) acts as a crosslinker for the diorganopolysiloxane by reacting with the functionality of the latter. It is further preferred that the above diorganopolysiloxane is either a linear or a branched polymer or copolymer of siloxane units selected from dimethylsiloxane units, methylphenylsiloxane units or methyltrifluoropropylsiloxane units. Most preferably, the diorganopolysiloxane of component (A) is a polydimethylsiloxane containing Si-bonded hydroxyl or methoxy functionality. The above mentioned silicon compound (ii) is preferably a siloxane resin comprising (CH₃)₃SiO_{½} and SiO₂ units and having a molar ratio of (CH₃)₃SiO_{½}/ SiO₂ between 0.4:1 and 1.2:1. The latter resin may be prepared according to methods taught in, e.g., U.S. Pat. No. 2,676,182 to Daudt et al. and typically contains from about 0.5 to about 3 weight percent of hydroxyl groups.

A highly preferred component (I) is a homogeneous blend of a hydroxyl-terminated polydimethylsiloxane, a trimethylsilyl- terminated polydimethylsiloxane having a viscosity in the range of about 1,000 to 50,000 mm²/s at 25° C., an alkyl polysilicate wherein the alkyl group has one to five carbon atoms, such as methyl polysilicate, ethyl polysilicate and propyl polysilicate, and a potassium silanolate catalyst reacted at a temperature of 50 to 300° C.

Component (II) is a polyisobutylene compound. The compound may be a polyisobutylene polymer or a polyisobutylene oligomer. Such oligomers or polymers are known in the art and many are available commercially in a variety of molecular weights and endgroup combinations. Component (II) of the invention is preferably a polyisobutylene compound having a number average molecular weight (Mₙ) of about 150 to about 6,000, preferably about 200 to about 3,000, more preferably about 200 to about 2,500, and most preferably about 200 to about 400. The polyisobutylene compound may have fully saturated end groups or it may have at least one terminal group which contain a functional group such as epoxy, methylpropenyl, halide, alkoxyphenylene, hydroxyl, carboxyl, chlorosilyl, vinyl, succinic anhydride, isocyanato, amino or amido. The polyisobutylene compound preferably has fully saturated endgroups, where the endgroup is for example an alkyl group, or has at least one terminal group which contains an unsaturated group. Preferred polyisobutylene compounds for component (II) have either two fully saturated end groups or have one vinyl or methylpropenyl end group and one saturated end group. Preferably the end group is independently selected from —C(CH₃)₃, —CH₂C(CH₃)₂H, —CH═C(CH₃)₂ (2-methylpropenyl), or —CH═CH₂ (vinyl).

The above-mentioned polyisobutylenes are available commercially in a variety of molecular weights from the Amoco Chemical Company (Chicago, Ill.) under the trade name Indopol™, or from the Polyesther Corporation (Southhampton, N.Y.) under the trade name Polysynlane™.

For the purposes of the present invention, the weight ratio of component (I) to component (II) can generally range from about 99:1 to about 1:99. More preferably the ratio ranges from about 90:10 to about 10:90, and it is highly preferred that it ranges from about 70:30 to about 30:70.

The dispersible silicone compositions of the present invention may further comprise component (III) a finely divided filler, as described above for component (iv). Specific examples of this filler include zirconium silica hydrogels (co-precipitated zirconium and silica) and hydrophobic precipitated silica, the latter being highly preferred. The amount of finely divided filler, component (III), to be added generally ranges from about 1 to 15 parts by weight, said parts by weight being based on the total weight of the composition.

The dispersible silicone compositions of the present invention may further comprise component (IV) a polyorganosiloxane of the type described for component (i), supra. Preferred polyorganosiloxanes in this regard are selected from the same trimethylsilyl-terminated polydimethylsiloxanes described for the preferred embodiments for (A) and the hydroxyl-terminated polydimethylsiloxanes for (B) of component (i), supra. For Component (IV), the preferred viscosity ranges of the polyorganosiloxanes of (A) and (B) are 2 to 100 mm²/s and 5 to 100,000 mm²/s, respectively. Particularly preferred viscosity ranges of these components are 10 to 50 mm²/s for (A) and 10 to 100 mm²/s for (B), the above viscosities being measured at 25° C. The amount of component (IV) to be added generally ranges from about 10 to 100 parts by weight, said parts by weight being based on the total weight of the composition.

The dispersible silicone compositions of the present invention can further comprise component (V) mineral oil. The term “mineral oil” as used herein refers to hydrocarbon oils derived from carbonaceous sources, such as petroleum, shale, and coal, and equivalents thereof. The mineral oil of component (V) can be any type of mineral oil, many of which are commercially available, including heavy white mineral oil which is high in paraffin content, light white mineral oil, petroleum oils such as aliphatic or wax-base oils, aromatic or asphalt-base oils, or mixed base oils, petroleum derived oils such as lubricants, engine oils, machine oils, or cutting oils, and medicinal oils such as refined paraffin oil. The above mentioned mineral oils are available commercially at a variety of viscosities from Amoco Chemical Company (Chicago, Ill.) under the tradename Amoco White Mineral Oil, from Exxon Company (Houston, Tex.) under the tradenames Bayol™, Marcol™, or Primol™, or from Lyondell Petrochemical Company (Houston, Tex.) under the trade name Duoprime® Oil. Preferably the mineral oil has a viscosity of from about 10 to about 50 millipascal-seconds at 40° C. The amount of mineral oil (V) depends on the types of components (I) and (II) employed however, generally, about 500 to 1000 parts by weight of mineral oil is employed, said parts by weight being based on the total weight of the composition.

When mineral oil is present in the compositions of this invention, the dispersible silicone compositions of the present invention can also comprise component (VI) a saturated or unsaturated bisamide such as those disclosed in U.S. Pat. No. 4,107,073, incorporated herein by reference to teach bisamides which are suitable for use in the dispersible silicone compositions of this invention. Preferred bisamides are those having the formula RC(O)N(H)—(CH₂)ₙ—N(H)C(O)R where n is an integer from 1 to 6, and R is a saturated or unsaturated, straight or branched chain hydrocarbyl group having from 5 to 22 carbon atoms. Particularly preferred as the bisamide is ethylene bis-stearamide. The amount of bisamide (VI) to be used in the compositions is generally at about 0.01 to about 5 parts by weight per 100 parts by weight of mineral oil, and preferably is at about 0.01 to 2 parts by weight per 100 parts by weight of mineral oil.

In addition to the above-mentioned components, the dispersible silicone compositions of the present invention may also contain adjuvants such as corrosion inhibitors and dyes. The compositions of the present invention may be prepared by blending components (I) and (II), and any optional components, to form a homogenous mixture. This may be accomplished by any convenient mixing method known in the art such as a spatula, mechanical stirrers, in-line mixing systems containing baffles, blades, or any of the like mixing surfaces including powered in-line mixers or homogenizers, a drum roller, a three-roll mill, a sigma blade mixer, a bread dough mixer, and a two roll mill. Although the order of mixing is not considered critical, it is preferred to first mix components (I) and (II) and then disperse the finely divided filler (III) in this combination by using a high shear mixer, and then optionally adding polyorganosiloxane (IV). It is also preferred that components (I) and (II), and optionally (III) and/or (IV) be first blended to together and then this mixture is preferably added to the mineral oil (V) or is added to a mixture of mineral oil (V) and bisamide (VI).

The present invention also relates to a process for controlling foam in a foaming system wherein the above-described dispersible silicone compositions may simply be added to a foaming or foam-producing system, in an amount sufficient to reduce foaming, as determined by routine experimentation. Typically, the compositions of the present invention are added at a concentration of about 0.001 to 0.1 parts by weight based on the weight of the foaming system, however the skilled artisan will readily determine optimum concentrations after a few routine experiments. The method of addition is not critical, and the dispersible silicone composition may be metered in or added by any of the techniques known in the art. Examples of foaming systems contemplated herein include media encountered in the production of phosphoric acid and in sulphite or sulphate process pulping operations, bauxite digestion medium in the production of aluminum, metal working fluids, paper manufacture, detergent systems, hydrocarbon fluid based systems, etc. The compositions of the present invention can be used as, for example, any kind of foam control composition, i.e. as defoaming compositions and/or antifoaming compositions. Defoaming compositions are generally considered as foam reducers whereas antifoaming compositions are generally considered as foam preventors. The compositions of this invention find utility as foam control compositions in various media such as inks, coatings, paints, detergents, pulp and paper manufacture, textile dyes, and hydrocarbon oil containing fluids.

All parts and percentages in the examples are on a weight basis unless indicated to the contrary. PIB as used hereinbelow denotes polyisobutylene. All viscosities were measured on a Brookfield Viscometer. The number average molecular weight of the compounds was measured by gel permeation chromatography. The following materials were employed in the preparation of the dispersible silicone compositions:

Silicone Composition A was prepared according to method disclosed in Example 1 of Aizawa et al., in U.S. Pat. No. 4,639,489, cited supra. This composition contained 60 parts of a trimethylsilyl-terminated polydimethylsiloxane having a viscosity of 1,000 mm²/s at 25° C.; 29 parts of a hydroxyl-terminated polydimethylsiloxane having a viscosity of 12,500 cs at 25° C.; 2.9 parts of ethyl polysilicate (“Silicate 45” of Tama Kagaku Kogyo Co., Ltd., Japan); 4.8 parts of a potassium silanolate catalyst; 2.9 parts of Aerogel #200 silica (Nippon Aerogel Co., Japan) having a surface area of 200 m²/g; and 4.8 parts of hydroxyl-terminated polydimethylsiloxane having a viscosity of 40 mm²/s at 25° C. In addition to the above ingredients, this formulation also included 0.3 parts of ethanol as part of the catalyst, 0.1 part water adsorbed on the silica and 0.1 part of L-540, added as a process dispersant. L-540 (Union Carbide Corp., Danbury, Conn.) is described as a silicone polyether block copolymer wherein the polyether blocks consist of 50/50 mole percent of polyoxyethylene/polyoxypropylene.

PIB A=Polysynlane™, described as a saturated polyisobutylene having a number average molecular weight of about 380, having one terminal group of the formula

CH₃

—CH₂—CH

CH₃

the other terminal group being of the formula —C(CH₃)₃. It is a product of Polyesther Corporation, Southhampton, N.Y.

PIB B=Indopol™ L-14, described as a vinyl-terminated polyisobutylene having a number average molecular weight of about 370, a product of the Amoco Chemical Company, Chicago, Ill. One terminal group of this oligomer has the vinyl-like structure (2-methylpropenyl) —HC═C(CH₃)₂, the other terminal group having the formula —C(CH₃)₃.

PIB C=Indopol™ L-50, similar to PIB B, but having a number average molecular weight of about 455.

PIB D=Indopol™ L-100, similar to PIB B, but having a number average molecular weight of about 510.

PIB E=Indopol™ H-40, similar to PIB B, but having a number average molecular weight of about 750.

PIB F=Indopol™ L-65, similar to PIB B, but having a number average molecular weight of about 435.

Mineral Oil A is a heavy paraffinic mineral oil having a viscosity of about 177 millipascal-seconds (mPa·s) at 25° C. from Fisher Scientific Company (Pittsburgh, Pa.).

Mineral Oil B is a mineral oil having a viscosity of about 10-40 millipascal-seconds (mPa·s) at 40° C.

### EXAMPLE 1

Silicone Composition A and PIB B-E were mixed at various weight ratios until a uniform consistency was achieved. After 24 hours at 25° C., the samples were inspected to determine if they were still uniform, stable mixtures. The results are shown in Table 1 hereinbelow.

TABLE 1
Weight Ratio of Silicone composition A to PIB

| | PIB | | | | |
|---|---|---|---|---|---|
| SAMPLE | TYPE | 70/30 | 60/40 | 50/50 | 40/60 |
| 1 | B | Stable | Stable | Stable | Stable |
| 2 | C | 2 Phases | 2 Phases | 2 Phases | 2 Phases |
| 3 | D | 2 Phases | 2 Phases | 2 Phases | 2 Phases |
| 4 | E | 2 Phases | 2 Phases | 2 Phases | 2 Phases |

The mixtures of Sample 1 at the various weight ratios denoted in Table 1, were then placed in a 40° C. oven and monitored six weeks for any sign of separation. No separation of phases or change in appearance was noted in any samples.

### EXAMPLE 2

Silicone Composition A and PIB A were mixed at various weight ratios. These mixtures were evaluated after 24 hours at 25° C. Table 2 illustrates that all of the mixtures remained as one phase and homogeneous.

TABLE 2
Weight Ratio of Silicone composition A to PIB

| | PIB | | | | |
|---|---|---|---|---|---|
| SAMPLE | TYPE | 70/30 | 60/40 | 50/50 | 40/60 |
| 5 | A | Stable | Stable | Stable | Stable |

The mixtures of sample 5 were then placed in a 40° C. oven and monitored for six weeks. No significant change in appearance was noted and no phase separation occurred.

### EXAMPLE 3

Three separate lots of Silicone Composition A and PIB B were mixed at weight ratios of 50/50, 57/43 and 67/37 respectively. Each was mixed at 200, 400 and 800 RPM in succession and their viscosities were measured after each mixing step. Table 3 lists the original viscosity for each of the three lots of Silicone Composition A, and the subsequent range of viscosities measured after the mixing steps carried out on each blend.

TABLE 3

| | | | Average Viscosity |
|---|---|---|---|
| | PIB | Silicone Comp. A | of Blends (mPa·s) |
| SAMPLE | TYPE | Viscosity (mPa·s) | after mixing |
| 6 | B | 19,650 | 1650-3100 |
| 7 | B | 32,350 | 2900-6300 |
| 8 | B | 46,000 | 1920-4000 |

Table 3 shows that by blending PIB B with Silicone Composition A, the viscosity of the blend is much lower than that of the silicone composition itself, thus showing that the PIB is a good delivery vehicle for the silicone composition.

### EXAMPLE 4

Foam control composition 1 was a blend of 40 parts by weight mixture of Silicone Composition A and 60 parts by weight of PIB B. To formulate this mixture into a mineral oil based foam control composition, 10.80 grams of this mixture was blended with 70.51 grams of Mineral Oil A and 20.00 grams of a 10% by weight dispersion of ethylene bis-stearamide in Mineral Oil B.

Foam control composition 2 was the same as composition 1, except that hydrophobic silica was formulated into the foam control composition in addition to the ethylene bis-stearamide. 9.60 grams of the Silicone Composition A-PIB B blend was mixed with 55.50 grams of Mineral Oil A, 20.00 grams of a 10% by weight dispersion of ethylene bis-stearamide in Mineral Oil B, and 15.00 grams of a 20% by weight dispersion of hydrophobic silica in Mineral Oil B.

Foam control composition 3 was a blend of 50 parts by weight of Silicone Composition A and 50 parts by weight of PIB B. To formulate this mixture into a mineral oil based foam control composition, 9.62 grams of this mixture was blended with 70.49 grams of Mineral Oil A and 20.00 grams of a 10% by weight dispersion of ethylene bis-stearamide in Mineral Oil B.

Foam control composition 4 was the same as composition 3, except that hydrophobic silica was formulated into the foam control composition in addition to the ethylene bis-stearamide. 9.53 grams of the Silicone Composition A-PIB B blend was mixed with 55.50 grams of Mineral Oil A, 20.00 grams of a 10% by weight dispersion of ethylene bis-stearamide in Mineral Oil B, and 15.00 grams of a 20% by weight dispersion of hydrophobic silica in Mineral Oil B.

Foam control composition 5 was a blend of 60 parts by weight of Silicone Composition A and 40 parts by weight of PIB B. To formulate this mixture into an oil based foam control composition, 9.50 grams of this mixture was blended with 70.51 grams of Mineral Oil A and 20.00 grams of a 10% by weight dispersion of ethylene bis-stearamide in Mineral Oil B.

Foam control composition 6 was the same as composition 5, except that hydrophobic silica was formulated into the foam control composition in addition to the ethylene bis-stearamide. 9.49 grams of the Silicone Composition A-PIB B blend was mixed with 55.50 grams of Mineral Oil A, 20.00 grams of a 10% by weight dispersion of ethylene bis-stearamide in Mineral Oil B, and 15.93 grams of a 20% by weight dispersion of hydrophobic silica in Mineral Oil B.

Foam control composition 7 was a blend of 70 parts by weight of Silicone Composition A and 30 parts by weight of PIB B. To formulate this blend into an oil based foam control composition, 4.80 grams of this mixture was blended with 60.31 grams of Mineral Oil A and 20.02 grams of a 10% by weight dispersion of ethylene bis-stearamide in Mineral Oil B.

Foam control composition 8 was the same as composition 7, except that the amount of the Silicone Composition A-PIB B blend was doubled. 9.57 grams of this blend was mixed with 55.50 grams of Mineral Oil A, 20.00 grams of a 10% by weight dispersion of ethylene bis-stearamide in Mineral Oil B, and 15.02 grams of a 20% by weight dispersion of hydrophobic silica in Mineral Oil B.

Comparative foam control composition 1 was a composition in which no blend of the present invention was used in preparing the foam control composition. The amount of Mineral Oil A used was increased to compensate for the lack of the presence of the Silicone Composition A-PIB blend. 65.01 grams of Mineral Oil A was mixed at room temperature with 20.00 grams of a 10% by weight dispersion of ethylene bis-stearamide in Mineral Oil B, and with 15.00 grams of a 10% wt dispersion of hydrophobic silica in Mineral Oil B.

The foam control compositions described above were then tested for their capacity to reduce or eliminate foaming in a recirculating pump test. In this test, 400 cc of Kraft pulp black liquor (the liquor comprised sodium lignin sulfonate, pentosan sugars, tall oil soaps, sodium carbonate, sodium sulfide and sodium hydroxide dissolved in water with a solids content of about 15% and a pH of 13.5 at 20° C.) was circulated with Nitrogen injected into the liquor stream to maximize foaming. The liquid volume in the test unit is set at 14 cm of height within the vertical column in which foam rise is measured. At the start of the test, which is conducted at 177° F., the foam column is allowed to rise to a height of 21 cm. At that point, 100 microliters of one of the foam control compositions described above is injected by a syringe into the circulating liquor stream. Foam height as a function of time was then monitored and recorded and the results are shown in Table 4 hereinbelow.

TABLE 4

| Foam | Sili- | Foam Control | Foam Height (cm) at | | |
|---|---|---|---|---|---|
| Control | cone | Composition | 15 | 2.5 | 10 |
| Composition | (ppm) | (ppm) | sec. | min. | min. |
| 1 | 10.1 | 237.5 | 16.0 | 22.0 | 28.5 |
| 2 | 9.1 | 237.5 | 17.0 | 24.0 | 27.0 |
| 3 | 11.4 | 237.5 | 15.0 | 22.0 | 26.0 |
| 4 | 11.3 | 237.5 | 15.0 | 27.0 | >32 |
| 5 | 13.5 | 237.5 | 16.5 | 21.0 | 29.5 |
| 6 | 13.4 | 237.5 | 15.0 | 22.5 | 28.5 |
| 7 | 8.0 | 237.5 | 16.5 | 22.5 | >32 |
| 8 | 15.0 | 237.5 | 15.0 | 22.0 | 30.5 |
| Compar. #1 | 0.0 | 237.5 | 28.0 | >32* | |

*at 1.0 min.

### EXAMPLE 5

Foam control composition 10 was a blend of 63 parts by weight of Silicone Composition A having a viscosity of 19,650 mPa s and 37 parts by weight of PIB B.

Foam control composition 11 was the same as composition 10, except that Silicone Composition A had a viscosity of 32,350 mPa s.

Foam control composition 12 was the same as composition 10, except that Silicone Composition A had a viscosity of 46,000 mPa s.

Compositions 10, 11, and 12 were each divided into two portions and left to set for six weeks. One set of the samples was stored at 25° C., the other at 40° C. After the six week period, all were formulated into a mineral oil based foam control compositions. 9.50 grams of each of the 6 blends were then mixed with 55.50 grams of Mineral Oil A, 20.00 grams of a 10% by weight dispersion of ethylene bis-stearamide in Mineral Oil B, and 15.00 grams of a 20% by weight dispersion of hydrophobic silica in Mineral Oil B. These compositions were then tested using the recirculating pump test described in Example 4. Foam height as a function of time was then monitored and recorded and the results are shown in Table 5 hereinbelow.

TABLE 5

| Foam | Sili- | Foam Control | Foam Height (cm) at | | |
|---|---|---|---|---|---|
| Control | cone | Composition | 15 | 2.5 | 5* |
| Composition | (ppm) | (ppm) | sec. | min. | min. |
| 10 at 25° C. | 13 | 237.5 | 16.0 | 19.5 | 270 |
| 10 at 40° C. | 13 | 237.5 | 15.0 | 19.5 | 270 |
| 11 at 25° C. | 13 | 237.5 | 15.5 | 21.0 | 290 |
| 11 at 40° C. | 13 | 237.5 | 16.0 | 21.0 | 290 |
| 12 at 25° C. | 13 | 237.5 | 15.5 | 18.5 | 260 |
| 12 at 25° C. | 13 | 237.5 | 19.0 | 20.5 | 300 |

*sum total of foam at 5 min.

### EXAMPLE 6

A silicone composition prepared by reacting 95 parts of a polydimethylsiloxane (fluids ranging in viscosity from 350 to 1000 mm²/s) and 5 parts of fumed silica (5 parts) in the presence of a strong acid catalyst was mixed with PIB A. The weight ratios of silicone composition to PIB mixed were 90/10, 80/20, 60/40, 50/50 and 30/70, respectively. After 24 hours, the 90/10, 80/20 and 60/40 blends remained stable and one phase while the others had separated.

### EXAMPLE 7

A silicone composition prepared by reacting 88 parts of a polydimethylsiloxane having a viscosity of 1000 mm^{2/}s, 10 parts of silica, 3 parts of a siloxane resin comprising (CH₃)₃SiO_{½} units and SiO_{4/2} units wherein the ratio of (CH₃)₃SiO_{½} units to SiO_{4/2} units was about 0.75:1, and a NaOH catalyst. This composition was then mixed with PIB A. The weight ratios of silicone composition to PIB mixed were 90/10, 80/20, 60/40, 50/50 and 30/70, respectively. After 24 hours, none of the silicone composition blended with PIB A had separated.

### EXAMPLE 8

A polydimethylsiloxane fluid having a viscosity of 1000 mm ²/s, was mixed with PIB B at the following weight part ratios: 30/70, 40/60, 50/50, 60/40, and 70/30. After setting for 24 hours at 25° C., all the blends had separated into two phases.

### EXAMPLE 9

A polydimethylsiloxane fluid having a viscosity of 1000 mm²/s was mixed with PIB A at the following weight part ratios: 30/70, 40/60, 50/50, 60/40, and 70/30. After setting for 24 hours at 25° C., all the blends appeared clear. But upon inversion of the samples a refraction pattern was noted that indicates incomplete dispersion.

### EXAMPLE 10

Silicone Composition A and PIB F were mixed at weight part ratios of 70/30, 60/40, 50/50, and 40/60, respectively. These were evaluated after 48 hours at 25° C. All of the samples showed some degree of phase separation, with the rate of separation increasing as the PIB content increased.

### EXAMPLE 11

Silicone Composition A was blended with a polydimethylsiloxane having a viscosity of about 1000 mm²/s at 25° C., with a hydroxy end-blocked polydimethylsiloxane fluid having a viscosity of about 70 mm²/s at 25° C. at a weight ratio of about 1.2:1.2:1.0, respectively. This silicone mixture was then blended with PIB B. A second blend was made using the silicone mixture described above and PIB C. Both were allowed to set for 48 hours at room temperature and their appearance evaluated. The first blend remained a one phase material with no significant separation of the components. The second blend on the other hand had separated into two distinct phases in roughly the same volume proportions as the original amounts of silicone and PIB that were mixed.

### EXAMPLE 12

Foam control composition 13 was a blend of 60 parts by weight of Silicone Composition A and 40 parts by weight of PIB B. To formulate this blend into a mineral oil based antifoam, 9.2 grams of the above referenced blend was mixed with 55.8 grams of Mineral Oil A, 20.0 grams of a 10% by weight dispersion of ethylene bis-stearamide in Mineral Oil B, and 15.0 grams of a 20% by weight dispersion of hydrophobic silica in Mineral Oil B.

Foam control Composition 14 was the same as composition 13, except that PIB F was used in place of PIB B.

Foam control Composition 15 was the same as composition 13, except that PIB D was used in place of PIB B.

Foam control Composition 16 was the same as composition 13, except that PIB E was used in place of PIB B.

Comparative foam control composition 2 did not contain a Silicone Composition A-PIB blend. The comparative composition was prepared by mixing 65.01 grams of Mineral Oil A, 20.00 grams of a 10% by weight dispersion of ethylene bis-stearamide in Mineral Oil B, and 15.00 grams of a 10% wt dispersion of hydrophobic silica in Mineral Oil B at room temperature.

The foam control compositions described above were tested for their capacity to reduce or eliminate foaming by the recirculating pump test described in Example 4. The results of the tests are shown in Table 6 below.

TABLE 6

| Foam | | Foam | | | |
|---|---|---|---|---|---|
| Control | Sili- | Control | Foam Height (cm) at | | |
| Compo- | cone | Composition | 15 | 2.5 | 5 |
| sition | (ppm) | (ppm) | sec. | min. | min. |
| 13 | 13.1 | 237.5 | 15.5 | 18.5 | 21.5 |
| 14 | 13.1 | 237.5 | 15.5 | 17.5 | 21.5 |
| 15 | 13.1 | 237.5 | 15.0 | 19.5 | 30.5 |
| 16 | 13.1 | 237.5 | 28.0 | >32* | >32* |
| Compar. #2 | 0.0 | 237.5 | 28.0 | >32* | >32* |

*at 1.0 min.

### EXAMPLE 13

100 grams of Silicone Composition A and 100 grams of Mineral Oil B were mixed in a stainless steel beaker for 5 minutes using steel blades at 300 RPM. After twenty-four hours at 25° C., the dispersion had cleanly separated into two distinct phases. Remixing the sample restores the homogeneous character to the mixture, but upon standing for less than 4 hours separation of the components again is evident.

### EXAMPLE 14

This blend was the same as Sample 1 in Example 1, a mixture of 50/50 weight ratio of Silicone Composition A and PIB B.

### EXAMPLE 15

1000 mm²/s polydimethylsiloxane fluid and PIB A were mixed at a weight ratio of 50/50. Then the silicone solids were reduced to 10% wt by blending 1 gram of this mixture with 4 additional grams of PIB A.

### EXAMPLE 16

10 grams of 350 mm²/s polydimethylsiloxane fluid was mixed with 10 grams of PIB A. Then the silicone solids were reduced to 10% wt by blending 1 gram of this mixture with 4.0 additional grams of PIB A.

TABLE 7
Stability as a Function of Hydrocarbon Diluent

| EXAMPLE | Appearance at 24 Hour | Appearance at 72 Hour |
|---|---|---|
| 14 | Stable | Stable |
| 13 | Separated | Separated |
| 15 | Slight Separation | Separated |
| 16 | Slight Separation | Separated |

Examples 14, 15, 16 were then tested in hardwood pulp liquor, approximately 10-11% solids from the Upper Peninsula of Michigan, using a Burrell Twin Arm Shaker Model AA. Temperature of the liquor at the start of the test was 84-85° C. Antifoam was dosed as ppm of actives as noted in Table 8. Shake times were 10, 60, 120 seconds and collapse and break times in seconds were recorded for each shake cycle. Collapse occurs when the foam height has fallen to 0.5 cm or below over the majority of the surface. There may appear to be a slightly higher portion at the glass interface due to the meniscus effect. Break occurs when the clear smooth surface of the solution shows through the collapsed foam. The size of the break is generally not critical since once the breaking starts the clear area expands rapidly. The Shake Test using the Burrell Twin Arm Shaker were conducted by weighing 0.00±0.05 grams of black liquor into a 8 oz French Square glass jar and cap loosely, placing the jar of black liquor in a lab oven to heat to black liquor solution to 85° C., removing the black liquor solution from oven and recording the temperature of the solution, weighing the desired amount of antifoam concentrate on the analytical balance, adding the antifoam concentrate into black liquor solution, putting the resulting solution into the Shaker, and then the solution is shaken in the Shaker for a 10 second shake time, 60 second shake time, and 120 second shake time. The collapse and break times for each shake test are then recorded.

TABLE 8
Shake Testing of Examples 14, 15, 16 in Hardwood Pulp Liquor

| | Antifoam | Silicone | 10 Second Shake | | 60 Second Shake | | 120 Second Shake | |
|---|---|---|---|---|---|---|---|---|
| Example | ppm | ppm | Collapse | Break | Collapse | Break | Collapse | Break |
| Liquor Control | 0 | 0 | >120 | >120 | >120 | >120 | >120 | >120 |
| PIB B Control | 157 | 0 | >120 | >120 | 12 | >120 | >120 | >120 |
| PIB A Control | 144 | 0 | 43 | >120 | 7 | >120 | 45 | >120 |
| 14 | 148 | 14.8 | 6 | 9 | 8 | >120 | 18 | >120 |
| 15 | 142 | 14.2 | 7 | 95 | 31 | >120 | >120 | >120 |
| 16 | 143 | 14.3 | 5 | >120 | 24 | >120 | >120 | >120 |

The invention, Example 14, is significantly better defoamer across the test range than Examples 15 and 16 and the PIB controls.

Examples 14, 15, 16 were then tested in softwood pulp liquor, approximately 12-14% solids from a mill in Wisconsin, using a Burrell Twin Arm Shaker. Temperature of the liquor at the start of the test was 84-85° C. Antifoam was dosed as ppm of actives as noted in Table 9. Shake times were 10, 60, 120 seconds and collapse and break times in seconds were recorded for each shake cycle.

TABLE 9
Shake Testing of Examples 14, 15, 16 in Softwood Pulp Liquor

| | Antifoam | Silicone | 10 Second Shake | | 60 Second Shake | | 120 Second Shake | |
|---|---|---|---|---|---|---|---|---|
| Example | ppm | ppm | Collapse | Break | Collapse | Break | Collapse | Break |
| Liquor Control | 0 | 0 | >120 | >120 | >120 | >120 | >120 | >120 |
| PIB B Control | 155 | 0 | >120 | >120 | >120 | >120 | >120 | >120 |
| PIB A Control | 152 | 0 | >120 | >120 | >120 | >120 | >120 | >120 |
| 14 | 155 | 15.5 | 5 | 6 | 7 | 8 | 9 | 10 |
| 15 | 153 | 15.3 | 26 | 43 | 30 | 44 | 43 | 92 |
| 16 | 155 | 15.5 | 48 | 113 | 77 | >120 | >120 | >120 |

Results for softwood mirror those for hardwood, but the differentiation is greater since the softwood is a more aggressive defoamer than the hardwood liquor.

### EXAMPLE 17

5.69 grams of Example 9 was mixed with an additional 34.3 grams of PIB A. To this was added 9.99 grams of a paste containing of 20 grams of Sipemat® 13 hydrophobic silica (DeGussa) and 80 grams of Mineral Oil B. The mixture was blended for 5 minutes at 500 RPM. Within 24 hours the mixture had separated. The example was tested for its defoaming performance in softwood liquor as described above and the results are reported in Table 10 below.

### EXAMPLE 18

5.73 grams of a mixture of a 50/50 weight ratio of Silicone Composition A and PIB A was blended with 34.3 grams of additional PIB A. To this was added 10.03 grams of a paste containing 20 grams of Sipemat® D13 hydrophobic silica (DeGussa) and 80 grams of Mineral Oil B. The mixture was blended for 5 minutes at 500 RPM. Within 24 hours the mixture had only slightly separated. The example was tested for its defoaming performance in softwood liquor as described above and the results are reported in Table 10 below.

TABLE 10
Shake Testing of Examples 17, 18 in Softwood Pulp Liquor

| | Antifoam | Silicone | 10 Second Shake | | 60 Second Shake | |
|---|---|---|---|---|---|---|
| Example | ppm | ppm | Collapse | Break | Collapse | Break |
| Liquor | 0 | 0 | >120 | >120 | >120 | >120 |
| Control | | | | | | |
| 17 | 133 | 7.5 | 0 | 1 | 3 | 58 |
| 18 | 134 | 7.7 | 0 | 0 | 14 | 95 |

Example 18, the invention, is preferred because it is more stable, equivalent in defoaming at a 10 second shake time, and only somewhat less effective as a defoamer at the 60 second shake time.

1. A dispersible silicone composition comprising a blend of:
(I) a silicone composition prepared by reacting at a temperature of 50° C. to 300° C. a mixture comprising:
(i) 100 parts by weight of at least one polyorganosiloxane selected from
(A) a polyorganosiloxane having a viscosity of about 20 to 100,000 mm²/s at 25° C. and being expressed by the general formula R¹ₐSiO_{(4-a)/2} in which R¹ is a monovalent hydrocarbon or halogenated hydrocarbon group having 1 to 10 carbon atoms and a has an average value of 1.9 to 2.2,
(B) a polyorganosiloxane having a viscosity of 200 to about 100 million mm²/s at 25° C. expressed by the general formula R²_{b}(R³O)_{c}SiO_{(4-b-c)/2} in which R² is a monovalent hydrocarbon or halogenated hydrocarbon group having 1 to 10 carbon atoms, R³ is hydrogen or a monovalent hydrocarbon group having 1 to 10 carbon atoms, b has an average value of 1.9 to 2.2 and c has a sufficiently large value to give at least one —OR³ group in each molecule, at least one such —OR₃ group being present at the end of the molecular chain, or
(C) a mixture of (A) and (B);
(ii) 0.5 to 20 parts by weight of at least one silicon compound selected from
(a) an organosilicon compound of the general formula R⁴_{d}SiX_{4-d} in which R⁴ is a monovalent hydrocarbon group having 1 to 5 carbon atoms, X is selected from a halogen atom or a hydrolyzable group and d has an average value of one or less,
(b) a partially hydrolyzed condensate of said compound (a),
(c) a siloxane resin comprising (CH₃)₃SiO_{½} units and SiO_{4/2} units wherein the ratio of (CH₃)₃SiO_{½} units to SiO_{4/2} units is 0.4:1 to 1.2:1, or
(d) a condensate of said compound (c) with said compound (a) or (b); and
(iii) a catalytic amount of a compound for promoting the reaction of components (i) and (ii); and
(II) a polyisobutylene compound.

2. A composition according to claim 1, wherein polyorganosiloxane (A) is a trimethylsiloxy-terminated polydimethylsiloxane having a viscosity of about 350 to 15,000 mm ²/s at 25° C.

3. A composition according to claim 1, wherein polyorganosiloxane (B) is a hydroxyl-terminated polydimethylsiloxane having a viscosity of about 1,000 to 50,000 mm²/s at 25° C.

4. A composition according to claim 1, wherein silicon compound (ii) is selected from ethyl polysilicate or a siloxane resin copolymer comprising (CH₃)₃SiO_{½} units and SiO₂ units in a molar ratio of approximately 0.4:1 to 1.2:1, respectively.

5. A composition according to claim 1, wherein the catalyst (iii) is selected from alkali metal hydroxides, alkali metal silanolates, alkali metal alkoxides, quaternary ammonium hydroxides, quaternary ammonium silanolates, quaternary phosphonium hydroxides, quaternary phosphonium silanolates, ammonium carbonate, or metal salts of organic acids.

6. A composition according to claim 1, wherein the mixture of (I) further comprises up to 30 parts by weight of: (iv) at least one finely divided filler.

7. A composition according to claim 6, wherein the finely divided filler (iv) is a hydrophobic silica having a surface area of about 50 to 300 m²/g.

8. A composition according to claim 1, wherein the mixture of (I) further comprises up to 20 parts by weight of: (v) a polyorganosiloxane having a viscosity of 5 to 200 mm²/s at 25° C. and being expressed by the general formula R⁶ₑ(R⁹O)_{f}SiO_{(4-e-f)/2} in which R⁶ is a monovalent hydrocarbon or halogenated hydrocarbon group having 1 to 10 carbon atoms, R⁹ is hydrogen or a monovalent hydrocarbon group having 1 to 10 carbon atoms, e is from 1.9 to 2.2 and f has a sufficiently large value to give at least two —OR⁹ groups in each molecule at the end of a molecular chain.

9. A composition according to claim 6, wherein the mixture of (I) further comprises up to 20 parts by weight of: (v) a polyorganosiloxane having a viscosity of 5 to 200 mm²/s at 25° C. and being expressed by the general formula R⁶ₑ(R⁹O)_{f}SiO_{(4-e-f)/2} in which R⁶ is a monovalent hydrocarbon or halogenated hydrocarbon group having 1 to 10 carbon atoms, R⁹ is hydrogen or a monovalent hydrocarbon group having 1 to 10 carbon atoms, e is from 1.9 to 2.2 and f has a sufficiently large value to give at least two —OR⁹ groups in each molecule at the end of a molecular chain.

10. A composition according to claim 8, wherein said polyorganosiloxane (v) is a hydroxyl-terminated polydimethylsiloxane having a viscosity of about 10 to 100 mm ²/s at 25° C.

11. A composition according to claim 9, wherein said polyorganosiloxane (v) is a hydroxyl-terminated polydimethylsiloxane having a viscosity of about 10 to 100 mm²/s at 25° C.

12. A composition according to claim 1, wherein one end group of said polyisobutylene is a saturated group and another end group is selected from a saturated group or an unsaturated group and said polyisobutylene has a number average molecular weight of 20 about 200 to about 400.

13. A composition according to claim 12, wherein the saturated endgroup is independently selected from —C(CH₃)₃ or —CH₂C(CH₃)₂H and the unsaturated endgroup is independently selected from —CH═C(CH₃)₂ or —CH═CH₂.

14. A composition according to claim 1, wherein the composition further comprises at least one component selected from (III) a finely divided filler or (IV) at least one polyorganosiloxane selected from a trimethylsilyl-terminated polydimethylsiloxane having a viscosity of about 2 to 100 mm²/s at 25° C., a trimethylsilyl-terminated polydimethylsiloxane having a viscosity of about 100 to 100,000 mm²/s at 25° C., or a hydroxyl-terminated polydiorganosiloxane polymer having a viscosity of about 5 to 100,000 mm²/s at 25° C.

15. A composition according to claim 6, wherein the composition further comprises at least one component selected from (III) a finely divided filler or (IV) at least one polyorganosiloxane selected from a trimethylsilyl-terminated polydimethylsiloxane having a viscosity of about 2 to 100 mm²/s at 25° C, a trimethylsiloxy-terminated polydimethylsiloxane having a viscosity of about 100 to 100,000 mm²/s at 25° C., or a hydroxyl-terminated polydiorganosiloxane polymer having a viscosity of about 5 to 100,000 mm²/s at 25° C.

16. A composition according to claim 8, wherein the composition further comprises at least one component selected from (III) a finely divided filler or (IV) at least one polyorganosiloxane selected from a trimethylsilyl-terminated polydimethylsiloxane having a viscosity of about 2 to 100 mm²/s at 25° C., a trimethylsiloxy-terminated polydimethylsiloxane having a viscosity of about 100 to 100,000 mm²/s at 25° C., or a hydroxyl-terminated polydiorganosiloxane polymer having a viscosity of about 5 to 100,000 mm²/s at 25° C.

17. A composition according to claim 9, wherein the composition further comprises at least one component selected from (III) a finely divided filler or (IV) at least one polyorganosiloxane selected from a trimethylsilyl-terminated polydimethylsiloxane having a viscosity of about 2 to 100 mm²/s at 25° C., a trimethylsiloxy-terminated polydimethylsiloxane having a viscosity of about 100 to 100,000 mm²/s at 25° C., or a hydroxyl-terminated polydiorganosiloxane polymer having a viscosity of about 5 to 100,000 mm²/s at 25° C.

18. A composition according to claim 1, wherein the composition further comprises at least one component selected from (V) mineral oil or a mixture of (V) mineral oil and (VI) a saturated or unsaturated bisamide.

19. A composition according to claim 6, wherein the composition further comprises at least one component selected from (V) mineral oil or a mixture of (V) mineral oil and (VI) a saturated or unsaturated bisamide.

20. A composition according to claim 8, wherein the composition further comprises at least one component selected from (V) mineral oil or a mixture of (V) mineral oil and (VI) a saturated or unsaturated bisamide.

21. A composition according to claim 9, wherein the composition further comprises at least one component selected from (V) mineral oil or a mixture of (V) mineral oil and (VI) a saturated or unsaturated bisamide.

22. A method for controlling foam in a foam producing system comprising adding to the foam producing system the composition of claim 1.

23. A method for controlling foam in a foam producing system comprising adding to the foam producing system the composition of claim 6.

24. A method for controlling foam in a foam producing system comprising adding to the foam producing system the composition of claim 8.

25. A method for controlling foam in a foam producing system comprising adding to the foam producing system the composition of claim 9.
